(19) United States
(12) Patent Application Publication
(10) Pub. No.: US 2009/0289426 A1
(43) Pub. Date: Nov. 26, 2009

(54) AIR STORAGE SYSTEM FOR AN AIR SUSPENSION SYSTEM IN A HEAVY VEHICLE

(75) Inventors: Christian Oscarsson, Stenungsund (SE); Anders Trygg, Onsala (SE)

Correspondence Address: WRB-IP LLP, 1217 KING STREET, ALEXANDRIA, VA, 22314, US

(73) Assignee: Volvo Lastvagnar AB, Goteborg (SE)

(21) Appl. No.: 12/295,734

(22) PCT Filed: Apr. 26, 2007
(86) PCT No.: PCT/SE2007/000407

§ 371 Date: Oct. 2, 2008

(30) Foreign Application Priority Data
Apr. 26, 2006 (SE) 0600935-1

(51) Int. Cl. B60G 17/015

(52) U.S. Cl. 280/5.503

(57) ABSTRACT

An air storage system is provided for an air suspension system in a large vehicle and includes at least one tire, preferably at least one set of tires provided on an axle of the vehicle. The system includes an air control arrangement adapted for selectively controlling the input and output of air from the at least one tire to the air suspension system based on data signal at least representing air pressure in the at least one tire at least when the tire is idle, i.e. not engaged in driving.

### BACKGROUND AND SUMMARY

The present invention relates to an air storage system for an air suspension system in a heavy vehicle.

Large or heavy vehicles, such as tires and buses, are usually equipped with air suspension systems, which use compressed air from auxiliary air tanks being supplied from an air compressor in the vehicle. These suspension systems are generally provided on the rear and/or front axles for absorbing the undulations of the road in order to provide a smooth ride and for reducing the load on the chassis and tires. An air suspension system comprises air-filled bellows instead of or as a supplement to spring elements, such as leaf springs. When the load increases, the bellow air pressure is increased for compensation in order to raise the chassis back to its preset height. Accordingly, the heavy vehicle can be kept level with automatic level control or be lowered or raised manually by the use of a control box, when loading or unloading, for example.

As more systems are being adapted for pneumatic operation in large vehicles, such as brakes, steering system, loading/unloading facilities, such as cranes, plates or flaps; and facilities for drivers convenience, such as seat height adjustment and the like, the demands for compressor output increases, while at the same time the installation space available for the auxiliary air tanks for the suspension system is reduced. Further, the installation space for auxiliary air storage tanks is limited in large vehicles due to the fact that in many countries vehicle size regulations limit the total installation space available.

U.S. application No. 2005/020095 discloses an air suspension system comprising a pneumatic levelling system for raising or lowering the ground clearance for an automotive vehicle, i.e. a car, which system is adapted to selectively receive and expel a fluid, such as air, and a spare tire in communication with said system, wherein said spare tire is adapted to provide said fluid to the levelling system. However the volume of air available from a spare tire is limited, and spare tires are not always available on-board many heavy vehicles.

Accordingly, it is desirable to provide an air storage system supplying air for an air suspension in a heavy vehicle, wherein the air storage system provides an increased compressed air storage capacity and which air storage system works even if the heavy vehicle is not provided with any spare tire.

According to an aspect of the present invention, an air storage system for an air suspension system in a large vehicle is provided, comprising at least one tire, preferably at least one set of tires, provided onto an axle of the vehicle; wherein the system comprises air control means adapted for selectively controlling the input and output of air from said at least one tire to said air suspension system based on data signals at least representing air pressure in said at least one tire at least when said tire is idle.

Accordingly, by using the idle tires to store air for an air suspension system, a substantial increase in on-board air storage volume is achieved. As an example, the total air volume in the tires on a 6×4 truck is about 1800 litres. By definition, the tires are idle, when they are not actively engaged in driving, e.g. when said at least one tire is provided on an additional axle which can be lifted, i.e. a tag axle or a pusher axle, which is raised to a position where the tire has no contact with the ground, or the vehicle is standing still. However, it is possible to use also wheels/tires which are engaged in driving, i.e. the tires being in contact with the ground during driving, as long as the air pressure of the tire is sufficient for the current driving situation.

In particular, the air consumption is increased during lifting and lowering such an additional axle of the vehicle. Air from tires on the additional axle to be raised can be used during the lifting operation because the current axle is unloaded. During conditions where the system has a low air consumption the tires on the raised additional axle can be filled with air to a pressure, preferably, a pressure higher than required for normal driving which allows air from the tires on the additional axle to be used later on during the lowering operation of the current additional axle.

Preferably, at least one set of tires on one axle is comprised within the system according to the invention, for equalizing resulting wear on said tires and for providing the possibility of using the same supply air lines for two or more tires at a time, which reduces total weight.

In a preferred embodiment of the system according to the invention, the air control means are further adapted for providing said at least one tire with driving pressure, when said at least one tire is actively engaged in driving, and with an increased pressure when said at least one tire is idle.

Thus, the system is provided with an automatic regulation of the tire pressure according to tire state, and the tire may be provided with a pressure suitable for driving during an active state of said tire, and may be provided with a pressure suitable for storing air in said tire, when the tire is idle. Thus, said at least one tire of the system according to the invention may further be used as extra air storage volume when said tires are only intermittently actively engaged are driving the vehicle. This is in particular advantageous, when the vehicle is standing still during extended periods of time, e.g. when loading/unloading or while engaged in construction work or the like.

In a preferred embodiment of the system according to the invention said at least one tire is mounted on an additional axle. Thus, the extra air storage volume provided by such tire or tires on a raised additional axle may be available for the suspension system, when said vehicle is being driven, which increases the total air storage volume available at any given time in said vehicle. When the additional axle is lowered, the tire volumes thereon may preferably also be utilized for air storage, when the vehicle is at rest.

In yet a further embodiment of the system according to the invention said data signal further is representing that the additional axle is raised. Accordingly the processor is provided with the information whether an additional axle is in fact raised, in which case the tires upon the raised axle may be utilized by said system for storing air both during driving and during stand still.

In an embodiment of the system according to the invention said air control means comprise a processor for controlling at least a valve on an air supply line for air communication with said air suspension system. Thus, said air control means are adapted to automatically control and regulate the tire pressure for an increased storage pressure in order to accommodate an increased amount of compressed air inside said at least one tire. Accordingly, the air storage system according to the invention is adapted to supply stored compressed air to the air suspension system and to provide the tire volumes with compressed air from the air compressor and/or auxiliary air tanks.

In a further embodiment of the system according to the invention said air control means comprises a tire air pressure sensor for measuring the pressure of said at least one tire and providing a pressure data signal based thereon. Accordingly, the air control means are provided with individual air pressure data signals from each tire in the system, based on which the system may regulate and store said air inside each tire of the system. Alternatively, other pressure gauges may be employed, which directly and/or indirectly senses the air pressure within each tire within the system.

In a further embodiment of the system according to the invention said data signal further is representing that that the large vehicle is at rest. In that case, the processor is provided with the information whether the vehicle is not being driven, in which case tires on any lowered additional axle and the remaining tires may be utilized for storing air for the air suspension system.

In a further embodiment of the system according to the invention said air control means further comprises the ability to selectively control the stored air available between at least two of the tires within the system. This reduces the possibility of an increased load on the tires for extended periods of time, and the possibility for the storage system to e.g. adjust for an uneven ground under the vehicle, and/or equalizing the air pressure of the tires in question to reduce wear from repeated storage cycles.

Further, if an air compressor, which is supplying air to the storage system according the invention, is not available, e.g. when the engine is turned off, the air storage system is adapted to control the air supply for the air suspension in a controlled manner being provided with the ability to distribute the available air between storage tires and suspension system for a controlled extraction of air from within said storage system. This provides for a controlled air supply for said air suspension during all driving states of said vehicle.

In another embodiment of the system according to the invention said air control means comprise a central tire inflation system (CTIS). Thus, an existing (CTIS system may be adapted for cooperation with the air suspension system for the control of air entering into and being stored within said at least one tire within the system, which reduces the number of parts needed for the provision of the system according to the invention, which reduces installation costs.

In yet another embodiment of the system according to the invention it comprises all of the total number of tires on the vehicle. Thus, the total number of tires provided on the large vehicle may be utilized for the system according to the invention, which provides a significant increase in the available air volume in the vehicle for the suspension system. Any number between one and all tires in the large vehicle are thus available for being utilized by the system according to the invention.

In yet another embodiment of the system according to the invention the air storage volume of said at least one tire is approx. 180 litres. Generally, a standard size tire for large vehicles may hold approximately this volume of air. When under the maximum storage pressure, such tire will obviously be expanded to an increased volume as compared to said initial storage volume. However, presently available cross ply and radial type tires are built to resist a volume increase, and accordingly will not experience a large increase in the total air volume available.

By the provision of a wheel arranged on an axle of a vehicle which wheel has a tire which is able to be filled by air and is connected to a pneumatically operated component, such as an air suspension system, of the vehicle for providing air to the component, wherein the air storage arrangement comprises an air control means adapted for selectively controlling transportation of air between said at least one wheel and the component based on received data which data contains information about the air pressure in the tire of said at least one wheel, the air storage capacity of for example a truck or the trailer of a vehicle combination can be increased. This in turn enables more equipment to be provided with air and/or the size and/or number of conventional air tanks to be reduced. The term “vehicle” is intended to comprise for example a tractor and/or a trailer in a vehicle combination. The pneumatically operated component is preferably the air suspension system of the vehicle. However, also other components for pneumatic operation, such as brakes, steering system, gear box, loading/unloading facilities, such as cranes, plates or flaps; and facilities for drivers convenience, such as seat heights adjustment and the like, can be provided with air by the air storage system according to the invention.

### BRIEF DESCRIPTION OF THE DRAWINGS

In the following, the invention will be described in more detail with reference to the schematic drawing, in which:

FIG. 1 shows one embodiment of an air storage system according to the present invention.

### DETAILED DESCRIPTION

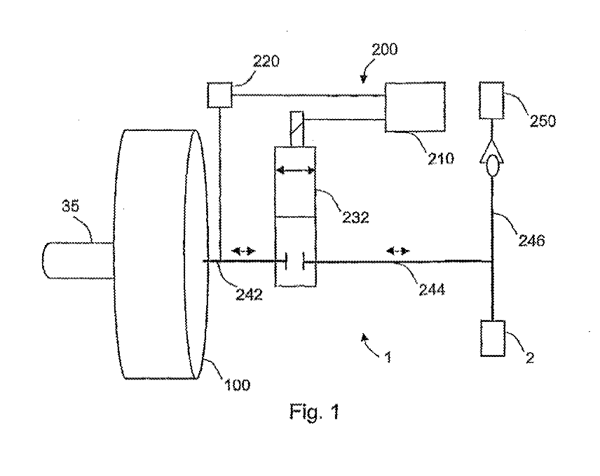

In FIG. 1 is shown one embodiment of an air storage system 1 according to the present invention, which comprises a wheel having a tire 100 on an axle 35 of a truck (not shown), which tire 100 is a receptacle for storing air; and control means 200 for controlling the input and output of air from the tire 100 to the air suspension system based on information concerning at least air pressure in said at least one tire. The air storage system can be used when said tire is idle, i.e. not engaged in driving, as well as when the current wheel/tire is engaged in driving.

Said air control means 200 may comprise a processor 210, which can be in communication with an air pressure sensor 220 for measuring the pressure of the tire 100, which sensor 220 delivers an air pressure data signal to said processor 210 representing the measured tire air pressure. Preferably, other data signals may be received by said processor representing information as to when the tire 100 is idle e.g. provided by a rotation sensor (not shown) or by the speedometer (not shown) and/or as to whether a additional axle (not shown), whereupon the tire 100 is mounted, is in a raised or lowered position, e.g. provided from an electric contact being activated thereby or provided from the bogie lift for raising and lowering the additional axle. Based on said data signals, the processor 210 is able to control the operation of a valve 232 either for evacuate air from or supplying air to said tire 100.

The air control means 200 can be adapted for controlling transportation of air between said at least one wheel/tire 100 and the air suspension system 2 based on information about the pressure in one or more air springs (not shown) of the air suspension system 2. Furthermore, the air control means 200 can be adapted for controlling transportation of air between said at least one wheel/tire 100 and the air suspension system 2 based on information about the load of the axle 35 onto which said at least one tire is arranged. The current axle load can be measured by any suitable means, preferably the pressure of air springs of the air suspension system is used to obtain information about the axle load. Other examples of possible input parameters for the air control means are vehicle height, vehicle speed, and bogie lift actuation.

The air pressure sensor 220 can either be connected to the line 242 by a suitable tubing and to the processor 210 by a suitable cabling, as shown in FIG. 1, or be integrated in the wheel. When integrated in the wheel, the communication to the processor 210 can be wireless.

The air from or to said valve 232 is fed along line 242 and 244, which latter line is in communication with a main air supply line 246, extending from an air compressor 250 to the air suspension system 2.

When supplying the tire 100 with air from the air compressor 250 and/or auxiliary air tanks, the processor 210 opens the valve 232 and the air compressor 250 and/or auxiliary air tanks fill up the tire 100 through lines 244 and 242, until a storage pressure is reached in the tire 100. Said storage pressure can be above the pressure sufficient for driving, and the maximum storage pressure is depending on the type and capacity of the tire, vehicle, and air compressor being used. When a suitable storage pressure is reached, as indicated by the pressure sensor 220, the valve 232 closes, and compressed air is left stored in the fire 100. For a typical radial tire for a large truck, suitable storage pressures ranges from 8 bars to the maximum pressure indicated on the wheel, such as e.g. 16 bars.

For extraction of air from the tire 100, when a storage pressure is present therein, the processor 210 opens the valve 232, and air flows along line 242 and 244 into the air suspension system 2. When the air volume needed is dispensed from the tire in question, i.e. a given tire pressure e.g. a lower storage pressure, a driving pressure or alternatively a minimum storage pressure is being reached as indicated by the pressure sensor 20 the valve 232 closes again under the control of processor 210. Below driving pressures, e.g. below eight bars, the extraction time will increase, which provides a slower filling of the air suspension system 2. This may be more or less important depending on which function the suspension system is used for, e.g. for supplying the air bellows, where the time for filling may be longer without problems, or for supplying air for raising/lowering a additional axle.

The above mentioned minimum and maximum storage pressures range, and driving pressure values far different driving situations may be provided in set or variable memory devices available for said processor 210, or may be provided in a program run by said processor 210, which preferably is an electronic control unit (ECU) presently available for heavy vehicles for controlling various parameters, such as e.g. tire pressures, said ECU being adapted for controlling said valve 232.

Alternative air control means to the means 200 shown in FIG. 1 are conceivable, e.g. by providing a central tire inflation system (CTIS) for adapting it to the inventive system. A CTIS is known to the skilled person and allows the driver to manually or automatically regulate the tire pressures to varied terrain conditions and driving speed for improved traction, Other means 200 are conceivable, e.g. embedded systems for control and tire pressure measurement.

Said air control means 200 may further comprise the ability to selectively control the distribution of stored air between at least two of the tires within the system. Accordingly, the tire pressures may be regulated between the tires of the system, and/or be supplied to the air suspension system independently from the engine being shut down. This reduces the possibility of an increased load on the tires for extended periods of time, and the possibility for the storage system to e.g. adjust for an uneven ground under the vehicle, and/or equalizing the air pressure of the tires in question to reduce wear from repeated storage cycles.

Each wheel/tire or wheels/tires of the air storage system 1 according to the invention are provided on an axle of the vehicle. The types of wheels/tires suitable for application by a system according to the invention are generally all types of conventional wheels/tires available for heavy vehicles which wheels are able to be filled by air. Any axle or axles of any type, and any tire or tires of any type are suitable for said system 1.

Preferably, the axle upon which one or more tires of the system 1 are provided is an additional axle, which may be lowered or raised according to vehicle loading. Accordingly, the tire or tires on the axle, when in a raised position, may be used as an air reservoir according to the invention, even when the vehicle is being driven.

The raising and lowering of the additional axles allow the driver to lift them on and off the ground, e.g. by the aid of the hydraulic or pneumatic system of the vehicle, the latter feeding the air suspension system. This is performed in order to comply with local regulations regarding weight distribution. In addition to weight distribution, increased mnanoeuvrability is another advantage provided by additional axles.

The main purpose of the invention is to provide for additional air storage to supply an air suspension system of the vehicle when a large amount of air is required in a short period of time. The inventive system is thus adapted to be used together with the air suspension system. The normal air supply for e.g. brakes etc. of the vehicle, which uses fixed air storage tanks, is thus not affected. The inventive system is advantageous for tracks when e.g. marshalling or on construction sites. A bus with a lowering floor can use the system such that when the bus stops at a stop the air pressure is raised in the tires so that the raising of the floor before leaving the stop is faster. This will save time for the bus company.

It has by the invention been realized, that a tire or tires on an additional axle, when in the raised or lowered position, and/or a tire or tires on a fixed front or rear axle, where the tires thereon are in contact with the ground, may be used as an air reservoir according to the invention. The additional air storage capacity can he provided when the tire or tires are idle, i.e. when the tires in question are not engaged in driving the vehicle, because the vehicle is standing still or the axle is raised, or during driving where the air storage tire/tires is in contact with the ground.

It is also possible to allow an increased pressure in the tires used for driving the vehicle when the vehicle is travelling at a low speed, i.e. when marshalling. This is advantageous when the vehicle is at e.g. a loading dock and requires a lot of air in order to raise and/or lower the vehicle frequently. By allowing an increased pressure in the tires when travelling at a low speed and/or in a specific geographic location, an efficient loading/unloading is achieved. This is due to the fact that the air suspension system can be pressurised quicker which means that the vehicle can be raised quicker and that an additional axle can be pressurised quicker when handling swap-bodies.

The number of tires, which is comprised within the system according to the invention, is any number from one to all tires on the vehicle, including any number of tires on a trailer for a tractor truck, in which case the air suspension system of the tractor truck and the trailer may be communicating.

The increased pressure may be any suitable pressure in the range of above driving pressure and to the maximum pressure before rupture of the tire in question. In general, conventional track tires, depending on size and load, will hold a pressure of above 8 bars, preferably between 9 and 12 bars.

In a further embodiment, the pressure sensor 220 may also be integrated in a central valve system together with valve 232. By using a centralised integrated valve system with one valve per tire controlling the air to each tire, it is possible to use only one pressure sensor instead of one pressure sensor per tire. In this way the pressure is measured on the air supply side. To measure the pressure in a specific tire, the valve controlling that tire is opened and the main supply valve is closed.

As a supplement to the storage volume provided by the tires of the heavy vehicle, conventional auxiliary air tanks may be provided for an increased air capacity. This provides for an added possibility of switching the supply between storage vessels and for interchanging air between these.

1. An air storage system for an air suspension system in a large vehicle, comprising at least one tire provided on an axle of the vehicle; wherein the system comprises air control means adapted for selectively controlling input and output of air from the at least one tire to the air suspension system based on data signals at least representing air pressure in the at least one tire at least when the tire is idle.

2 A system according to claim 1, wherein the air control means is further adapted for providing the at least one tire with driving pressure, when the at least one tire is actively engaged in driving; and with an increased storage pressure when the at least one tire is idle.

3. A system according to claim 2, wherein the at least one tire is mounted on a tag or pusher axle.

4. A system according to claim 3, wherein the data signal further is representing that the tag or pusher axle is raised.

5. A system according to claim 1, wherein the air control means comprises a processor for controlling at least a valve on an air supply line for air communication the air suspension system.

6. A system according to claim 1, wherein the air control means comprises a tire air pressure sensor for measuring the pressure of the at least one tire and providing a pressure data signal based thereon.

7. A system according to claim 1, wherein the air control means is adapted to selectively control stored air available between at least two of the tires within the system.

8. A system according to claim 1, wherein data signal represents that the large vehicle is at rest.

9. A system according to claim 1, wherein the air control means comprises a central tire inflation system (CTIS).

10. A system according to claim 1, comprising all tires on the vehicle.

11. A system according to claim 1, wherein the air control means is adapted for controlling transportation of air between the at least one tire and the air suspension system based on information about pressure in one or more air springs of the air suspension system.

12. A system according to claim 1, wherein the air control means is adapted for controlling transportation of air between the at least one tire and the air suspension system based on information about a load of the axle onto which the at least one tire is arranged.

13. An air storage arrangement for providing air to at least one pneumatically operated component of a vehicle, comprising at least one wheel arranged on an axle of a vehicle which wheel has a tire which is able to be filled by air and is connected to a pneumatically operated component of the vehicle for providing air to the component, wherein the air storage arrangement comprises an air control means adapted for selectively controlling transportation of air between the at least one wheel and the component based on received data which data contains information about the air pressure in the tire of the at least one wheel.

14. An arrangement according to claim 13, wherein the air control means is adapted for controlling transportation of air between the at least one wheel and the pneumatically operated component based on information about pressure in one or more air springs of an air suspension system of a vehicle.

15. An arrangement according to claim 13, wherein the air control means is adapted for controlling transportation of air between the at least one wheel and the pneumatically operated component based on information about a load of the axle onto which the at least one wheel is arranged.

16. An arrangement according to claim 13, wherein the pneumatically operated component is an air suspension system of a vehicle.
